(19) United States
(12) Patent Application Publication
(10) Pub. No.: US 2012/0163371 A1
(43) Pub. Date: Jun. 28, 2012

(54) Telephone System, Call Control Apparatus and Communication Connection Method

(76) Inventor: Kenichi Kitazawa, Hino-shi (JP)

(21) Appl. No.: 13/283,192

(22) Filed: Oct. 27, 2011

(30) Foreign Application Priority Data
Dec. 27, 2010 (JP) 2010-291302

(51) Int. Cl. H04L 12/66

(52) U.S. Cl. 370/352

(57) ABSTRACT

According to one embodiment, a telephone system includes a transmitter, a detector, a notification module and a controller. The transmitter transmits an outgoing request from a first server apparatus to a second server apparatus. The detector detects a response from the second terminal apparatus, at the second server apparatus. The notification module analyzes media information received at the second server apparatus from the second terminal apparatus and required to achieve peer-to-peer communication, and notifies the media information to the first server apparatus, when the detector detects the response from the second terminal apparatus. The controller causes the first server apparatus to perform the peer-to-peer communication between the first terminal apparatus and the second terminal apparatus based on the media information notified from the second server apparatus.

### CROSS-REFERENCE TO RELATED APPLICATIONS

This application is based upon and claims the benefit of priority from prior Japanese Patent Application No. 2010-291302, filed Dec. 27, 2010, the entire contents of which are incorporated herein by reference.

### FIELD

Embodiments described herein relate generally to a telephone system in which an IP-QSIG dedicated line connects a plurality of call control server apparatuses, each incorporating, for example, session initiation protocol (SIP) terminals, to a call control server apparatus for use in the telephone system, and to a communication connection method for use in the telephone system.

### BACKGROUND

In recent years, the IP telephone system has come into general use, in which video data and audio data are transmitted and received, in real time, as real-time transport protocol (RTP) packets. In the IP telephone system, call control servers and a plurality of IP telephone terminals are connected in an IP network. Each call control server can achieve communication between the IP telephone terminals and communication between any IP telephone terminal and an external terminal.

In the IP telephone system, to accomplish communication between any calling IP telephone terminal and the called IP telephone terminal, protocol such as SIP is used under the control of a call control server, thereby establishing a session between the calling IP telephone terminal and the called IP telephone terminal. After the session has been established, audio communication is performed by means of peer-to-peer connection in which the call control server need not perform an exchange processes. In the peer-to-peer connection of the IP telephone terminals, the IP telephone terminals exchanges audio packets, by using the audio media codec (e.g., G.711, G.722, G.729 or the like) common to them.

In the IP telephone system, the IP-QSIG dedicated line connects a plurality of call control servers. If communication is performed through the IP-QSIG dedicated line, the negotiation of media information may not be achieved because the protocol for the communication between any IP telephone terminal and any call control server differs from the protocol for the communication between the call control servers. In this case, the communication partners are connected while the media information items remains not identical, or they are disconnected from each other.

A media conversion function may be implemented in the call control server, or data may be set to each IP telephone terminal, which is identical to the media information stored in the call control server. If a media conversion function may be implemented in the call control server, however, the operating load on the CPU incorporated in the call control server will increase. Further, data may not be set to the IP telephone terminal to agree with the media information stored in the call control server, depending on the specification of the IP telephone terminal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing the configuration of an IP telephone system according to a first embodiment;

FIG. 2 is a block diagram showing the specific configuration of one of the call control servers according to the first embodiment;

FIG. 3 is a diagram showing exemplary contents of the routing table shown in FIG. 2;

FIG. 4 is a sequence diagram showing the negotiation performed to initiate communication in the first embodiment;

FIG. 5 is a diagram showing the structure of a NOTIFY message;

FIG. 6 is a sequence diagram showing the negotiation performed to initiate communication if a media conversion function is implemented in each call control server;

FIG. 7 is a sequence diagram showing the negotiation performed to initiate communication if no media conversion function is implemented in each call control server;

FIG. 8 is a block diagram showing the configuration of one of the call control servers according to a second embodiment;

FIG. 9 is a sequence diagram showing the negotiation performed to initiate communication in the second embodiment; and

FIG. 10 is a sequence diagram showing the negotiation performed to initiate communication between a transmitting SIP terminal and a receiving SIP terminal in a modification of the second embodiment.

### DETAILED DESCRIPTION

Various embodiments will be described hereinafter with reference to the accompanying drawings. In general, according to one embodiment, a telephone system includes a transmitter, a detector, a notification module and a controller. The transmitter transmits a outgoing request from a first server apparatus to a second server apparatus, when a first terminal apparatus registered the first server apparatus is operated to transmit data to a second terminal apparatus registered the second server apparatus. The detector detects a response from the second terminal apparatus, at the second server apparatus. The notification module analyzes media information received at the second server apparatus from the second terminal apparatus and required to achieve peer-to-peer communication, and notifies the media information to the first server apparatus, when the detector detects the response from the second terminal apparatus. The controller causes the first server apparatus to perform the peer-to-peer communication between the first terminal apparatus and the second terminal apparatus based on the media information notified from the second server apparatus.

### First Embodiment

The first embodiment is an IP telephone system. In this IP telephone system, a call control server of the receiving side notifies gives media information to a call control server of the transmitting side when it detects a response made by a transmitting SIP terminal of the receiving side.

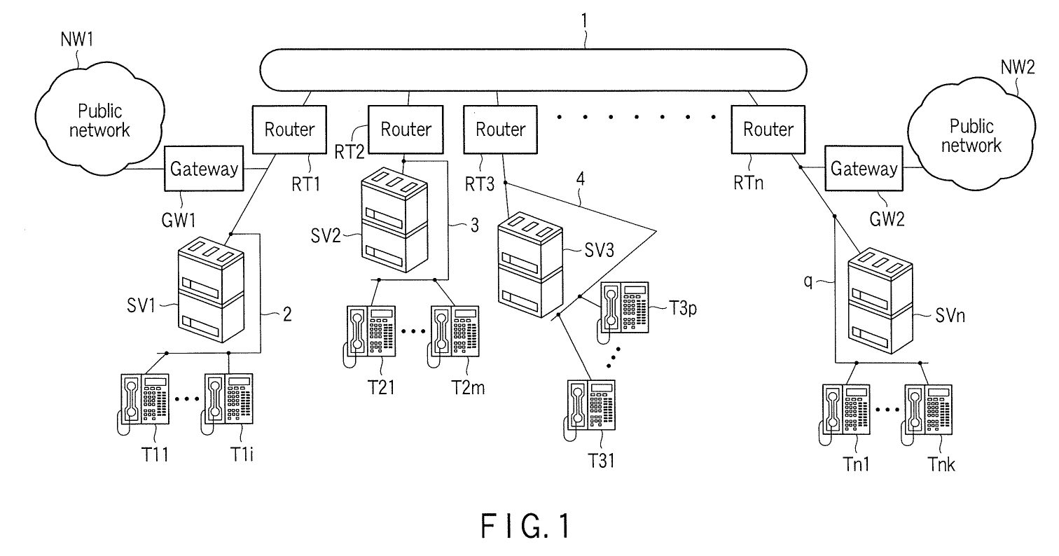

FIG. 1 is a diagram showing the configuration of an IP telephone system according to the IP telephone system according to the first embodiment.

The system has an IP network 1 is a communication network designed to achieve packet communication. The IP network 1 includes an IP-QSIG dedicated line. In the IP network 1, a plurality of call control servers SV1 to SVn (n: natural number) are connected to the IP-QSIG dedicated line.

To the call control server SV1, a plurality of terminal apparatuses, i.e., SIP terminals T11 to T1i (i: natural number), are connected by a local area network (LAN) 2. To the call control server SV2, SIP terminals T21 to T2m (m: natural number) are connected by a LAN 3. To the call control server SV3, SIP terminals T31 to T3p (p: natural number) are connected by a LAN 4. And, to the call control server SVn, SIP terminals Tn1 to Tnk (k: natural number) are connected by a LAN q.

The call control server SV1 is connected to the IP network 1 by a router RT1. The call control server SV2 is connected to the IP network 1 by a router RT2. Further, the call control servers SV3 to SVn are connected to the IP network 1 by routers RT1 to RTn, respectively.

To the call control server SV1, a gateway GW1 is connected. The gateway GW1 connects the IP network 1 to a public network NW1 and has a function of converting the communication protocol and the signal format, both for the communication between the public network NW1 and the IP network 1.

To the call control server SVn, a gateway GW2 is connected. The gateway GW2 connects the IP network 1 to a public network NW2 and has a function of converting the communication protocol and the signal format, both for the communication between the public network NW2 and the IP network 1.

The call control servers SV1 to SVn have an exchange control function of establishing session between the SIP terminals T11 to T1i, T21 to T2m and T31 to T3p and Tn1 to Tnk, or between the SIP terminals T11 to T1i, T21 to T2m and T31 to T3p and Tn1 to Tnk, on the one hand, and the public networks NW1 and NW2, on the other hand, in accordance with the, for example, the session initiation protocol (SIP). After the session has been so established, RTP packets can be transferred between transmitting SIP terminals and receiving SIP terminals, in the peer-to-peer connection, either directly or via the call control servers SV1 to SVn. Audio communication is thereby accomplished. The call control servers SV1 to SVn have another exchange control function of establishing session between them in accordance with, for example, IP-QSIG.

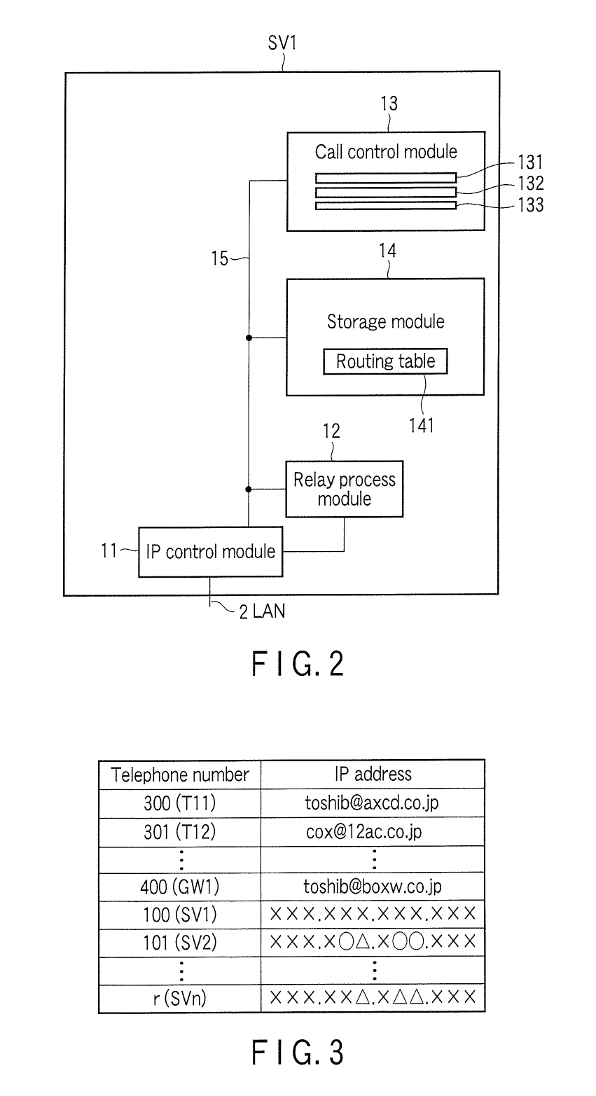

The call control servers SV1 to SVn are identical in configuration, each having several functions pertaining to the first embodiment. FIG. 2 is a block diagram showing the configuration of the call control server SV1, which will be described as representative.

As shown in FIG. 2, the call control server SV1 comprises an IP control module 11, a relay process module 12, a call control module 13, and a storage module 14. The IP control module 11, relay process module 12, call control module 13 and storage module 14 are connected to one another by a data highway 15.

To the IP control module 11, the LAN 2 is connected, as needed. The IP control module 11 performs an interface process with respect to the IP network 1 connected to it. The IP control module 11 transmits and receives various control data items to and from the call control module 13 through the data highway 15.

The relay process module 12 processes the control message and RTP packets the IP control module 11 has received.

The call control module 13 has a CPU, a ROM and a RAM, and performs a software process controls, controlling the other components of the call control server SV1.

The storage module 14 stores a routing table 141, etc. The routing table 141 is indispensable for the connection control of the call control module 13. As shown in FIG. 3, the routing table 141 consists of telephone numbers and IP addresses associated with the telephone numbers. The telephone numbers are ID data items allocated to the SIP terminals T11 to T1i and the gateways GW1. The IP addresses are variable network addresses. In the routing table 141, the nodes IDs allocated to the call control servers SV1 to SVn are associated with the IP addresses, respectively.

The call control module 13 comprises a detecting module 131, a notification control module 132, and a connection control module 133. On receiving a transmission request (SETUP message) from, for example, the SIP terminal T21 through the call control server SV2, the detecting module 131 calls the SIP terminal T11 which is to receive a call, and detects the response made by the SIP terminal T11.

On detecting a response made by the SIP terminal T11 which is to receive a call, the notification control module 132 analyzes media information supplied from the SIP terminal T11 (e.g., codec data items G.711, G.722, G.723, G.728 and G.729 and packet transmission intervals) and generates media information. The media information thus generated is incorporated into the SDP of, for example, a NOTIFY message. The NOTIFY message containing the media information is transmitted to the transmitting side.

On receiving the NOTIFY message coming from the receiving side, the connection control module 133 analyzes the NOTIFY message, determining whether the SDP of the NOTIFY message contains the media information available at the receiving side. If the SDP contains the media information, the connection control module 133 supplies the media information to the transmitting side. The peer-to-peer connection is thereby achieved between the transmitting SIP terminal and the receiving SIP terminal in accordance with the content of the media information.

How the telephone system configured as described above operates will be explained.

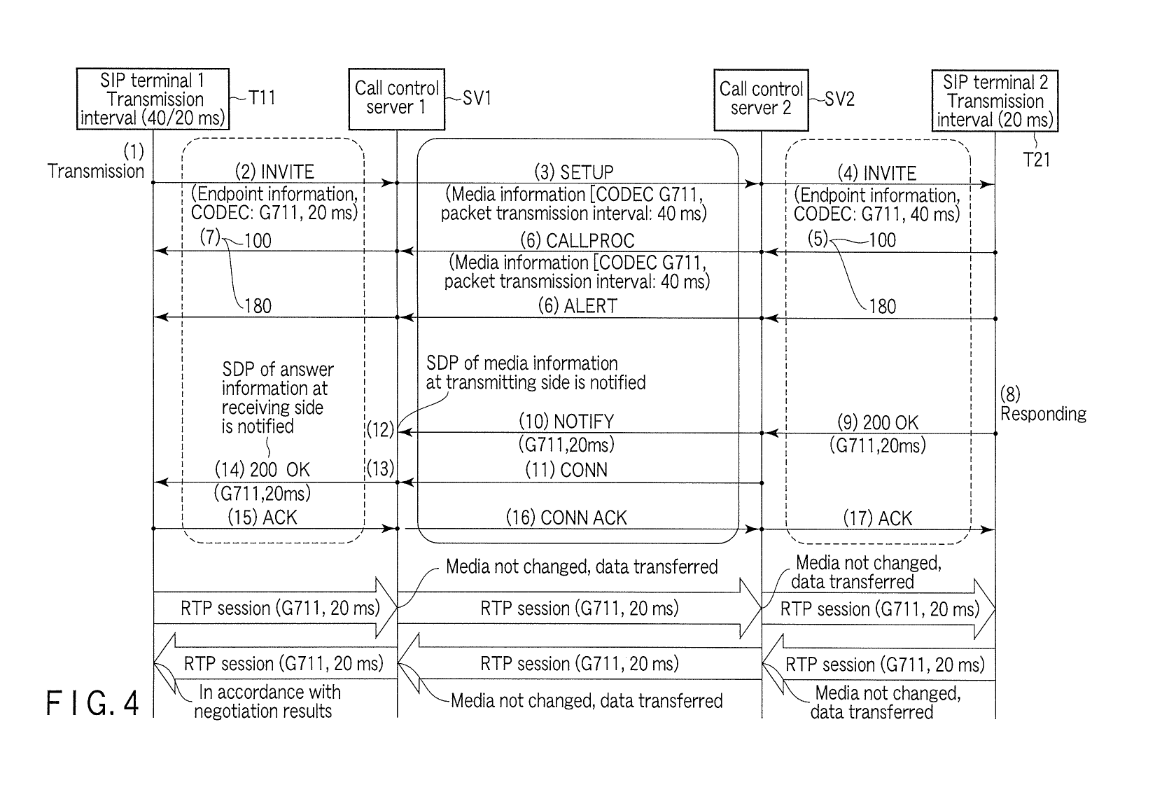

FIG. 4 is a sequence diagram showing the negotiation performed to initiate communication between SIP terminals T11 and T21. Here it is assumed that the call control servers SV1 and SV2 do not have a media conversion function.

Assume that the SIP terminal T11 registered in the call control server SV1 is operated, making a call to the SIP terminal T21 registered in the call control server SV2 (see (2) in FIG. 4). Then, the SIP terminal T11 transmits an outgoing request that contains the SDP of media information (i.e., INVITE message) (see (2) in FIG. 4).

On receiving the outgoing request, the call control server SV1 determines the media information that should be used in the IP-QSIG dedicated line, from the media information contained in the SDP, and generates a SETUP message defined by IP-QSIG. The SETUP message contains the transmitting-side identification data, data containing the codec used in the IP-QSIG dedicated line, for example, G. 711, and RTP packet transmission interval (40 ms). If the IP-QSIG dedicated line is used, the call control server SV1 utilizes the packet transmission interval of 40 ms in order to reduce the band used. The SETUP message is transmitted from the call control server SV1 to the call control server SV2 through the IP network 1 (see (3) in FIG. 4).

On receiving the SETUP message, the call control server SV2 transmits an INVITE message containing media information, to the receiving SIP terminal T21 (see (4) in FIG. 4). After receiving the INVITE message, the SIP terminal T21 analyzes the media information, determining whether the media information can be adjusted to the packet transmission interval notified, i.e., 40 ms. At the same time, the SIP terminal T21 sends 100 Trying and 180 Ringing to the call control server SV2, notifying that the call has arrived (see (5) in FIG. 4). The notification of call arrival is accomplished by generating a ringing tone or displaying a call arrival message.

On receiving the 100 Trying and 180 Ringing, the call control server SV2 transmits a messages (CALL PROC, ALERT) to the call control server SV1, informing the call control server SV1 that the SETUP message has been duly received (see (6) in FIG. 4). The SDP of the CALL PROC message contains the codec data and packet transmission interval of 40 ms of call control server SV2.

On receiving the CALL PROC message and ALERT message from the call control server SV2, the call control server SV1 transmits 100 Trying and 180 Ringing to the transmitting SIP terminal T11, informing the SIP terminal T11 that the call has duly arrived at the receiving SIP terminal T21 (see (7) in FIG. 4). The negotiation between the call control servers SV1 and SV2 is thereby established for the present.

Assume that the user of the SIP terminal T21 makes a response (see (8) in FIG. 4). Then, the SIP terminal T21 transmits a response message (200OK) to the call control server SV2 (see (9) in FIG. 4). The SDP of the response message (200OK) contains the codec data and packet transmission interval of 20 ms of the SIP terminal T21. The SIP terminal T21 cannot be adjusted to the packet transmission interval of 40 ms, because of its specification. Hence, the SIP terminal T21 sends back the response message in the packet transmission interval of 20 ms.

The call control server SV2 extracts the media information from the response message (200OK), and changes the packet transmission interval set for it, from 40 ms to 20 ms. Then, the call control server SV2 transmits a NOTIFY message containing the media information of the SIP terminal T21 (see (10) in FIG. 4). The NOTIFY message may be replaced by another type of a message, or may be a CONN message. Then, the call control server SV2 transmits, to the call control server SV1, information superimposed on a response message (CONN) and showing that the SIP terminal T21 has been connected to the call control server SV2 (see (11) in FIG. 4).

The call control server SV1 receives the NOTIFY message, acquiring the media information (see (12) in FIG. 4). Next, the call control server SV1 receives the CONN message (see (13) in FIG. 4). After receiving the CONN message, the call control server SV1 changes the packet transmission interval, from 40 ms to 20 ms, and transmits the 200OK message containing the codec data and packet transmission interval for the receiving SIP terminal T21, to the transmitting SIP terminal T11 (see (14) in FIG. 4). On receiving the 200OK message, the SIP terminal T11 adjusts its packet transmission interval to the value of 20 ms contained in the 200OK message, and sends ACK to the call control server SV1 (see (15) in FIG. 4).

On receiving ACK from the SIP terminal T11, the call control server SV1 transmits CONN ACK to the call control server SV2 (see (16) in FIG. 4). The call control server SV2 sends ACK to the SIP terminal T21 (see (17) in FIG. 4). As a result, a communication link is formed, which connects the transmitting SIP terminal T11 and the receiving SIP terminal T21, by using the call control servers SV1 and SV2. Thereafter, RTP packets are transferred at the packet transmission interval of 20 ms, accomplishing the communication between the SIP terminals T11 and T21.

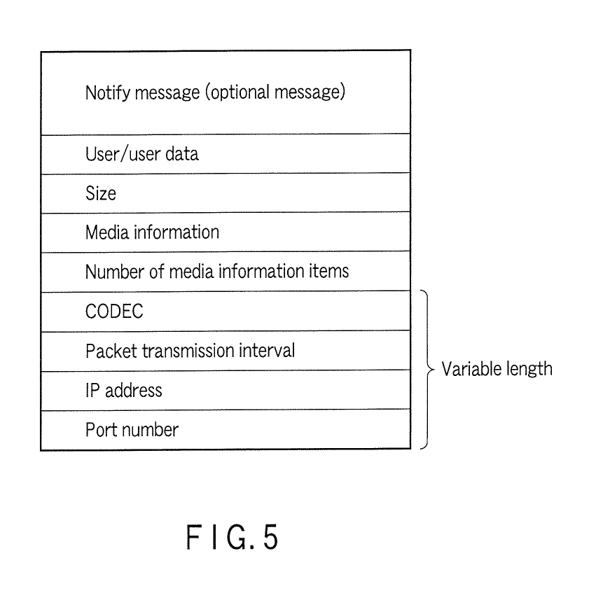

FIG. 5 is a diagram showing the structure of the NOTIFY message mentioned above. The NOTIFY message contains user/user data, size, media information, number of media information items, codec, packet transmission interval, IP address and port number. The user/user data is information that identifies the transmitting side and the receiving side. The size is information that represents the amount of video data, audio data and other data transferred between the transmitting side and the receiving side. The media information represents the type of media, such as video, audio or other. The number of media information items represents the number of video data items, audio data items or other data items, the number of video-audio combinations, or the number of audio-data combinations, which are transferred between the transmitting side and the receiving side. The IP address and the port number are allocated to the SIP terminal T21 that is the receiving side.

The negotiation between the SIP terminal T11 and the call control serve SV1 differs in timing from the negotiation between the call control servers SV1 and SV2. In view of this, the media conversion function may be implemented in the call control servers SV1 and SV2.

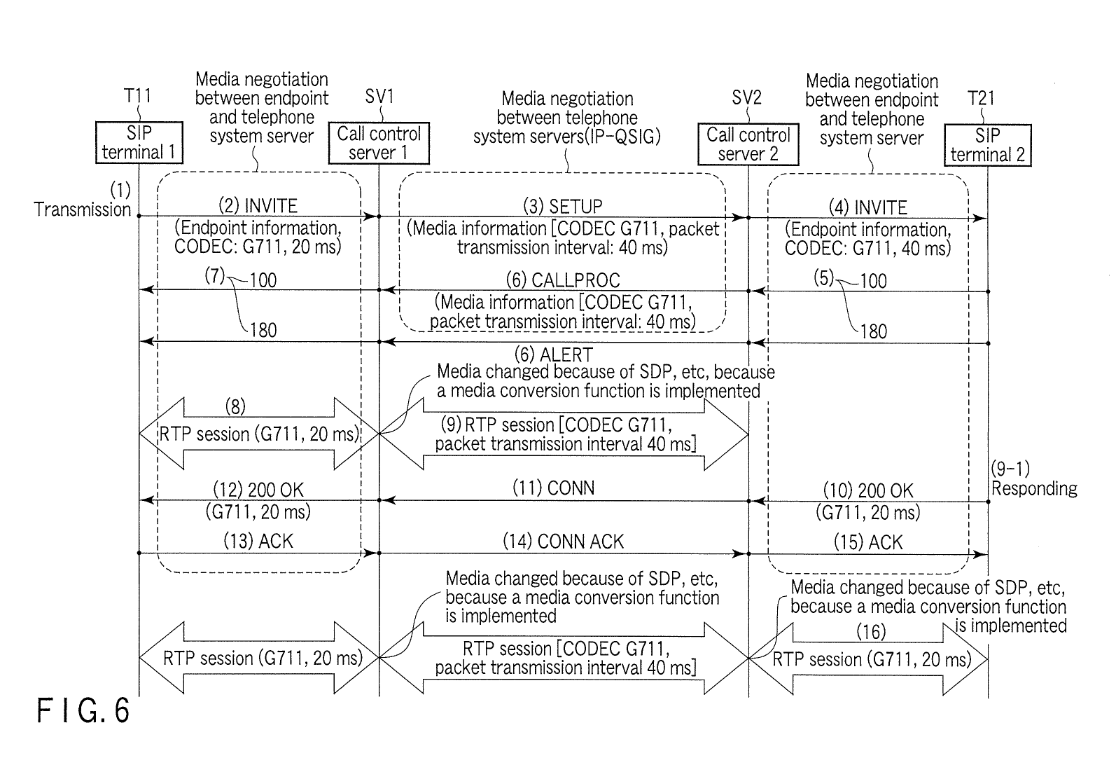

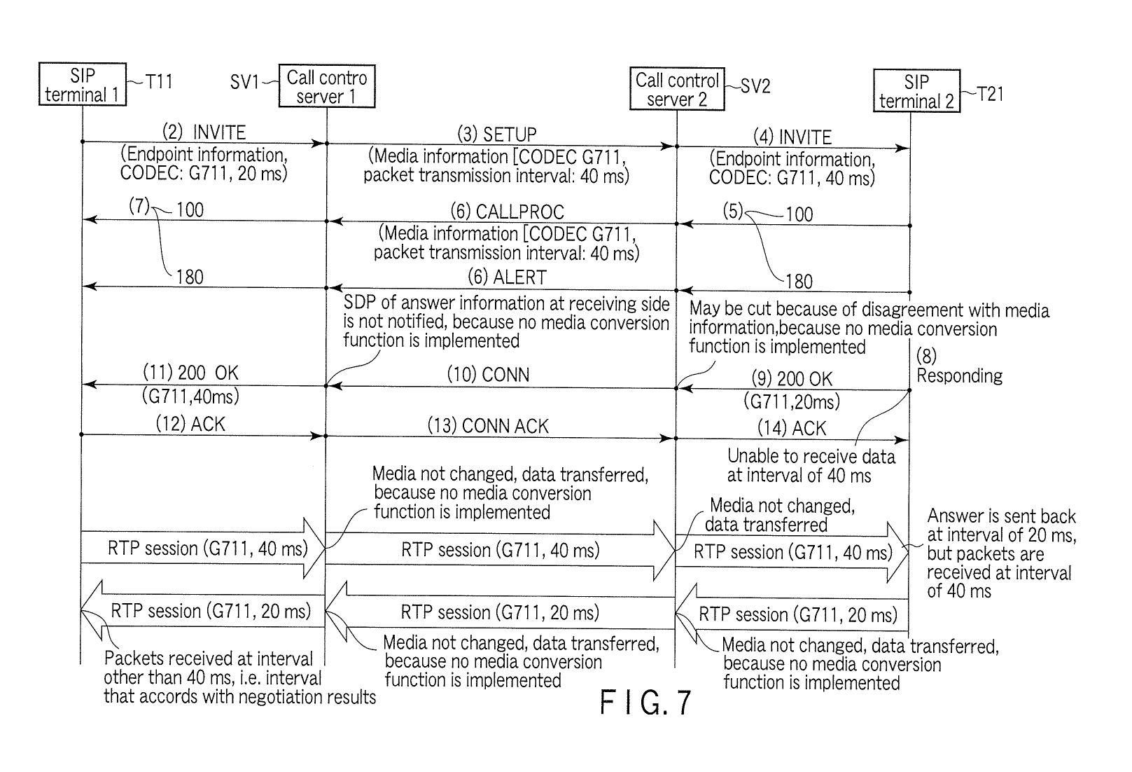

FIG. 6 is a sequence diagram showing the negotiation performed to initiate communication if the media conversion function is implemented in the call control servers SV1 and SV2. The components, data items and processes, which are identical to those shown in FIG. 4 are designated by the same reference numbers and will not be described in detail.

With regard to the data transmission between the SIP terminal T11 and the call control server SV1, the transmitting SIP terminal T11 transmits an INVITE message to the call control server SV1 (see (1) in FIG. 6). On receiving the INVITE message, the call control server SV1 transmits a SETUP message to the SIP terminal T21. In response to the SETUP message, the SIP terminal T21 sends 100 Trying and 180 Ringing to the call control server SV2. On receiving the 100 Trying and 180 Ringing, the call control server SV2 transmits a CALL PROC and an ALERT message to the call control server SV1. At this point, the call control server SV1 establishes an RTP session with the call control server SV2 that accords with the codec G.711 and packet transmission interval of 40 ms (see (9) in FIG. 6).

On receiving the CALL PROC and an ALERT message from the call control server SV2, the call control server SV1 transmits 100 Trying and 180 Ringing to the transmitting SIP terminal T11, establishing an RTP session of RTP packets with the SIP terminal T11, which accords with the codec G.71.1 and packet transmission interval of 20 ms (see (8) in FIG. 6).

Thereafter, the user of the SIP terminal T21 may make a response (see (9-1) in FIG. 6). Then, the SIP terminal T21 transmits a response message (200OK) to the call control server SV2 (see (10) in FIG. 6). The SDP of the response message (200OK) contains the codec data and packet transmission interval of 20 ms about the SIP terminal T21. In this instance, the SIP terminal T21 cannot accord with the packet transmission interval of 20 ms, because of its specification. Therefore, the SIP terminal T21 transmits a response message at the packet transmission interval of 20 ms.

On receiving the 200OK message from the SIP terminal T21, the call control server SV2 transmits, to the call control server SV1, the information superimposed on a response message (CONN) and showing that the SIP terminal T21 has been connected to the call control server SV2 (see (11) in FIG. 6).

After receiving the CONN message, the call control server SV1 transmits, to the transmitting SIP terminal T11, a 200OK message containing the codec data and packet transmitting interval of the receiving SIP terminal T21 (see (12) in FIG. 6). Then, the SIP terminal T11 sends ACK to the call control server SV1 (see (13) in FIG. 6).

On receiving the ACK from the SIP terminal T11, the call control server SV1 transmits CONN ACK to the call control server SV2 (see (14) in FIG. 6).

Then, the call control server SV2 transmits ACK to the SIP terminal T21 (see (15) in FIG. 6), establishing an RTP session with the SIP terminal T21, which accords with the codec G.711 and packet transmission interval of 20 ms (see (16) in FIG. 6).

Thus, even if the call control servers SV1 and SV2 differ in media information, the RTP session can be established because the call control servers SV1 and SV2 have the media conversion function and can therefore covert the media information. Nonetheless, since negotiations are performed independently, between the SIP terminal T11 and the call control serer SV1 and between the call control sever SV1 and the call control server SV2, they differ in timing as broken-line boxes indicate in FIG. 6. Further, the media conversion function implemented in both call control servers SV1 and SV2 inevitably increase the data-processing load on each call control sever.

If the media conversion function may not be implemented in the call control servers SV1 and SV2. In this case, however, the packet transmission between the SIP terminals T11 and T21 may be interrupted because of the difference in packet transmission interval, or an RTP session may be established while the call control servers SV1 and SV2 remains different in terms of packet transmission interval, as will be explained with reference to FIG. 7. The components, data items and processes, which are identical to those shown in FIG. 4 are designated by the same reference numbers in FIG. 7 and will not be described in detail.

If the user of the SIP terminal T21 makes a response (see (8) in FIG. 7), the SIP terminal T21 transmits a response message (200OK) to the call control server SV2 (see (9) in FIG. 7). The SDP of the response message (200OK) contains the codec data and packet transmission interval of 20 ms about the SIP terminal T21. In this instance, the SIP terminal T21 cannot accord with the packet transmission interval of 20 ms, because of its specification. Therefore, the SIP terminal T21 transmits a response message at the packet transmission interval of 20 ms.

On receiving the response message (200OK) from the SIP terminal T21, the call control server SV2 transmits, to the call control server SV1, the information superimposed on a response message (CONN) and showing that the SIP terminal T21 has been connected to the call control server SV2 (see (10) in FIG. 7). In this instance, the CONN message does not contain the codec data or packet transmission interval for the SIP terminal T21. Further, the packet transmission between the SIP terminals T11 and T21 may be interrupted because of the difference in packet transmission interval.

After receiving the CONN message, the call control server SV1 transmits, to the transmitting SIP terminal T11, a 200OK message containing the codec data and packet transmitting interval for the communication between the severs (see (11) in FIG. 7). Then, the SIP terminal T11 adjusts its packet transmission interval, from 20 ms to 40 ms contained in the 200OK message, and sends ACK to the call control server SV1 (see (12) in FIG. 7).

On receiving the ACK from the SIP terminal T11, the call control server SV1 transmits CONN ACK to the call control server SV2 (see (13) in FIG. 7). Then, the call control server SV2 transmits ACK to the SIP terminal T21 (see (14) in FIG. 7). As a result, a communication link is formed, which connects the transmitting SIP terminal T11 and the receiving SIP terminal T21, by using the call control servers SV1 and SV2. Thereafter, RTP packets are transferred from the SIP terminal T11 to the SIP terminal T21 at the packet transmission interval of 40 ms, and from the SIP terminal T21 to the SIP terminal T11 at the packet transmission interval of 20 ms.

Assume that the user of the SIP terminal T21 says, “Hello, Mr. Y.” Then, the SIP terminal T11 receives this talk at a packet transmission interval other than the interval of 40 ms, i.e., the result of the negotiation. Consequently, the talk may sound like “Hew Mr.” to the user of the SIP terminal T11, who finds it difficult for the user of the SIP terminal T11 to understand to understand the talk. Also assume that the user of the SIP terminal T11 says, “Thank you very much.” In this case, the SIP terminal T21 receives this talk at the packet transmission interval of 40 ms, and the talk sounds like “T^{˜}h^{˜}a^{˜}n^{˜}k y^{˜}o^{˜}u^{˜}. . . ” That is, each phoneme last longer than usual, making it difficult for the user of the SIP terminal T21 to understand to understand the talk.

To prevent this inconvenience, the call control server SV2 transmits a NOTIFY message to the call control server SV1 on the transmitting side when the SIP terminal T11 calls the SIP terminal T21 and the response from the SIP terminal T21 is detected. The NOTIFY message contains the media information representing the codec data and packet transmission interval of the SIP terminal T21. In accordance with the media information, the call control server SV1 first changes its packet transmission interval, from 40 ms to 20 ms and then transmits the media information of the receiving SIP terminal T21 to the SIP terminal T11. Next, the call control server SV1 establishes an RTP session between the SIP terminals T11 and T21, using the common packet transmission interval of 20 ms.

Hence, the media conversion function need not be implemented in the call control servers SV1 and SV2, and the same media information need not be stored in the call control servers SV1 and SV2 beforehand. Negotiation can yet be established between the SIP terminals T11 and T21 connected by the IP-QSIG dedicated line.

In the first embodiment described above, an existing control signal, such as the CONN message or NOTIFY message defined by IP-QSIG, can be used to transmit the media information from the call control server SV2 of the receiving side to the call control server SV1 of the transmitting side. Therefore, new dedicated control signals need not be generated. This facilitates the practical use of the first embodiment.

### Second Embodiment

In the second embodiment, the media information notified from the transmitting SIP terminal is incorporated into the outgoing request (SETUP message), which is sent to the call control server on the receiving side.

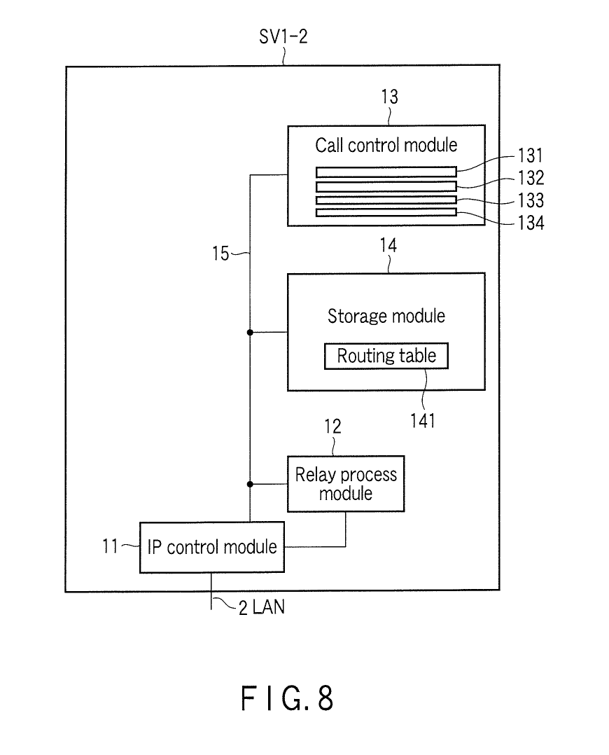

FIG. 8 is a block diagram showing the configuration of the call control servers SV1 to SVn according to the second embodiment are identical in configuration. The call control servers SV1 to SVn are identical in configuration, and the call control server SV1 will be described as call control server SV1-2. The components of the call control server SV1-2, which are identical to those shown in FIG. 2, are designated by the same reference numbers and will not be described in detail.

The call control server SV1-2 comprises a transmission-side media information notification module 134. On receiving the media information from SIP terminal T11, the transmission-side media information notification module 134 analyzes this media information. The media information analyzed is transmitted to the call control server SV2 of the receiving side.

How the second embodiment operates will be explained.

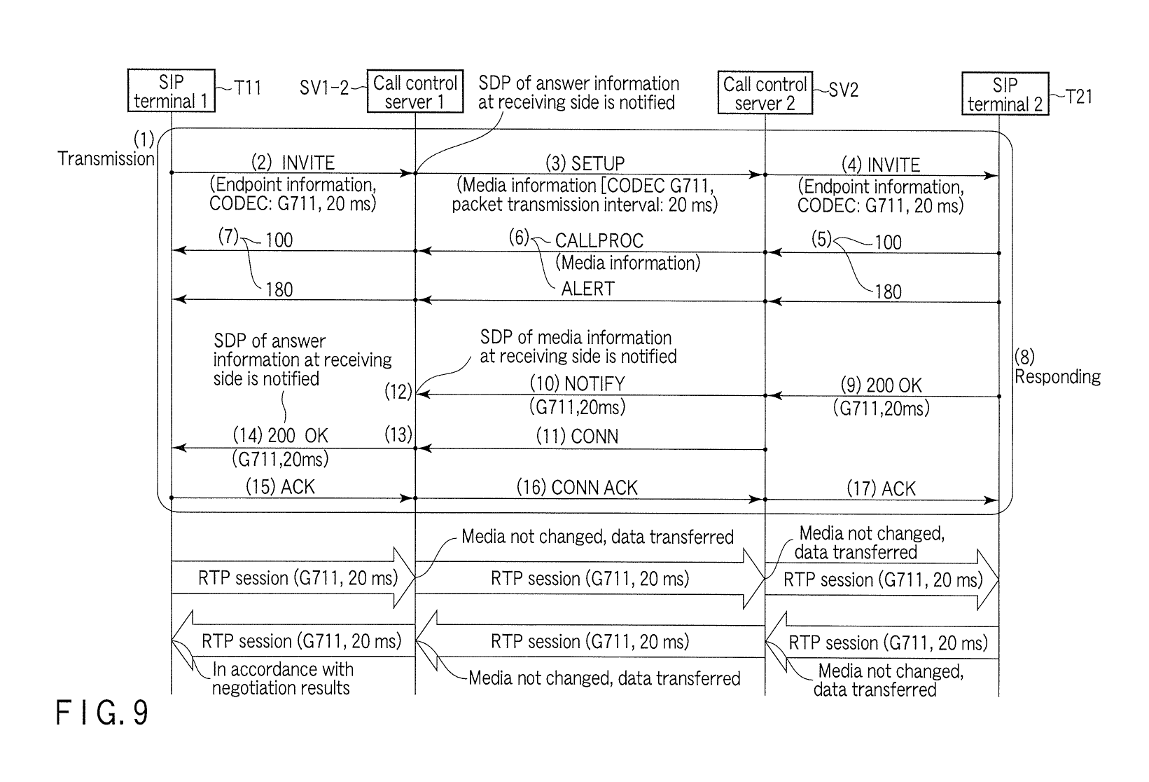

FIG. 9 is a sequence diagram showing the negotiation performed to initiate communication between, for example, the SIP terminals T11 and T21.

Assume that an operation is performed at the SIP terminal T11 registered the call control server SV1-2 to transmit data to the SIP terminal T21 registered the call control server SV2 (see (1) in FIG. 9). Then, the SIP terminal T11 transmits a transmission request (INVITE message) containing the media information for the call control server SV1-2 (see (2) in FIG. 9).

The call control server SV1-2 extracts the media information from the INVITE message it has received. If its packet transmission interval is set to 40 ms, the call control server SV1-2 changes the interval to 20 ms, and transmits a SETUP message that contains the media information available at the SIP terminal T11 (see (3) in FIG. 9).

On receiving the SETUP message, the call control server SV2 transmits the INVITE message containing the media information, to the SIP terminal T21 (see (4) in FIG. 9). After receiving the INVITE message, the SIP terminal T21 analyzes the media information. At the same time, the SIP terminal T21 transmits 100 Trying and 180 Ringing indicating that the call arrival has been informed, to the call control server SV2 (see (5) in FIG. 9). The call arrival is notified by generating a ringing sound or by displaying a call-arrival message.

On receiving the 100 Trying and 180 Ringing from the SIP terminal T21, the call control server SV2 transmits, to the call control server SV1-2, messages (CALL PROC and ALERT) showing that the SETUP message has been correctly received (see (6) in FIG. 9). SDP of the CALL PROC message contains the codec data about the call control server SV2 and the packet transmission interval of 20 ms.

On receiving the CALL PROC message and the ALERT message, the call control server SV1-2 transmits the 100 Trying and 180 Ringing to the SIP terminal T11 that has transmitted the transmission request. Thus, the call control server SV1-2 informs the transmitting SIP terminal T11 that the call-arrival message is being sent to the SIP terminal T21 (see (7) in FIG. 9).

If the user of the SIP terminal T21 operates the SIP terminal T21, making a response to the call-arrival message (see (8) in FIG. 9), the SIP terminal T21 transmits a response message (200OK) to the call control server SV2 (see (9) in FIG. 9). The SDP of the response message (200OK) contains the codec data and packet transmission interval (20 ms) about the SIP terminal T21.

The call control server SV2 extracts the media information from the response message (200OK) it has received, and transmits a NOTIFY message containing the media information available at the SIP terminal T21 (see (10) in FIG. 9). The NOTIFY message may be replaced by another type of a message, or may be a CONN message. Then, the call control server SV2 transmits, to the call control server SV1, the information superimposed on a response message (CONN) and showing that the SIP terminal T21 has been connected to the call control server SV2 (see (11) in FIG. 9).

The call control server SV1-2 receives the NOTIFY message, acquiring the media information (see (12) in FIG. 9). Next, the call control server SV1-2 receives the CONN message (see (13) in FIG. 9). After receiving the CONN message, the call control server SV1-2 transmits the 200OK message containing the codec data and packet transmission interval about the receiving SIP terminal T21, to the transmitting SIP terminal T11 (see (14) in FIG. 9). On receiving the 200OK message, the SIP terminal T11 sends ACK to the call control server SV1-2 (see (15) in FIG. 9).

On receiving ACK from the SIP terminal T11, the call control server SV1-2 transmits CONN ACK to the call control server SV2 (see (16) in FIG. 9). The call control server SV2 sends ACK to the SIP terminal T21 (see (17) in FIG. 9). As a result, a communication link is formed, which connects the transmitting SIP terminal T11 and the receiving SIP terminal T21, by using the call control servers SV1-2 and SV2. Thereafter, RTP packets are transferred at the packet transmission interval (20 ms), accomplishing communication between the SIP terminal T11 and the SIP terminal T21.

In the second embodiment, prior to data transmission, the call control server of the receiving side is notified of the media information available at the transmitting SIP terminal T11. Therefore, the media information to be used between the call control servers SV1-2 and SV2 can be determined so that it may agree with the media information available at the transmitting SIP terminal T11, before the response made by the receiving SIP terminal T21 is detected.

### Modification of the Second Embodiment

The modification is based on the assumption that the codec of any transmitting SIP terminal is G.711/G.729 and that the codec of any receiving SIP terminal is G.711.

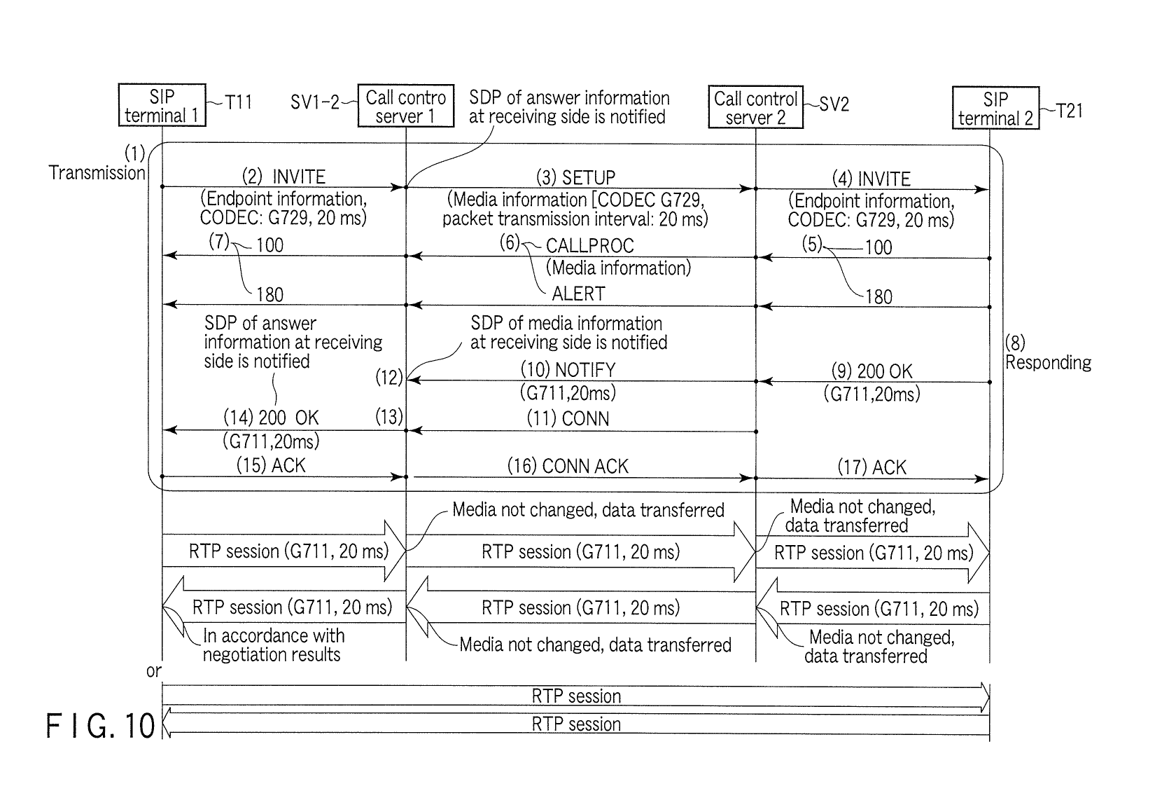

FIG. 10 is a sequence diagram showing the negotiation performed to initiate communication between, for example, the SIP terminals T11 and T21.

Assume that the SIP terminal T11 incorporated in the call control server SV1 is operated in order to transmit data to the SIP terminal T21 incorporated in the call control server SV2 (see (1) in FIG. 10). Then, the SIP terminal T11 transmits a transmission request (INVITE message) containing SDP of media information, to the call control server SV1-2 (see (2) in FIG. 10). In this case, the SIP terminal T11 transmits codec G.729.

The call control server SV1-2 extracts the media information from the INVITE message it has received. If the packet transmission interval for it is set to 40 ms, the call control server SV1-2 changes the interval to 20 ms and then transmits, to the call control server SV2, a SETUP message containing the media information available at the SIP terminal 11 (see (3) in FIG. 10).

On receiving the SETUP message, the call control server SV2 transmits the INVITE message containing media information, to the receiving SIP terminal T21, thereby making a call (see (4) in FIG. 10). After receiving the INVITE message, the SIP terminal T21 analyzes the media information. At the same time, the SIP terminal T21 transmits 100 Trying and 180 Ringing indicating that the call arrival has been informed, to the call control server SV2 (see (5) in FIG. 10). The call arrival is notified by generating a ringing sound or by displaying a call-arrival message.

On receiving 100 Trying and 180 Ringing from the SIP terminal T21 from the SIP terminal T21, the call control server SV2 transmits, to the call control server SV1-2, messages (CALL PROC and ALERT) showing that the SETUP message has been correctly received (see (6) in FIG. 9). The SDP of the CALL PROC message contains the codec data about the call control server SV2 and the packet transmission interval of 20 ms.

On receiving the CALL PROC message and the ALERT message, the call control server SV1-2 transmits 100 Trying and 180 Ringing to the transmitting SIP terminal T11. Thus, the call control server SV1-2 informs the transmitting SIP terminal T11 that the call-arrival message is being sent to the SIP terminal T21 (see (7) in FIG. 10).

If the user of the SIP terminal T21 operates the SIP terminal T21, making a response to the call-arrival message (see (8) in FIG. 10), the SIP terminal T21 transmits a response message (200OK) to the call control server SV2 (see (9) in FIG. 10). The SDP of the response message (200OK) contains the codec G.711 and packet transmission interval of 20 ms about the SIP terminal T21. In this instance, the SIP terminal T21 cannot accord with the codec G.729, because of its specification. Therefore, the SIP terminal T21 transmits a response message, by using code G.711.

The call control server SV2 extracts the media information from the response message (200OK) it has received, and transmits a NOTIFY message containing the media information available at the SIP terminal T21 (see (10) in FIG. 10). The NOTIFY message may be replaced by another type of a message, or may be a CONN message. Then, the call control server SV2 transmits, to the call control server SV1, the information superimposed on a response message (CONN) and showing that the SIP terminal T21 has been connected to the call control server SV2 (see (11) in FIG. 10).

The call control server SV1-2 receives the NOTIFY message, acquiring the media information (see (12) in FIG. 10). Next, the call control server SV1-2 receives the CONN message (see (13) in FIG. 10). After receiving the CONN message, the call control server SV1-2 transmits the 200OK message containing the codec data and packet transmission interval for the receiving SIP terminal T21, to the transmitting SIP terminal T11 (see (14) in FIG. 10). On receiving the 200OK message, the SIP terminal T11 adjusts its codec G.729 to codec G.711 contained in the 200OK message, and sends ACK to the call control server SV1-2 (see (15) in FIG. 10).

On receiving ACK from the SIP terminal T11, the call control server SV1-2 transmits CONN ACK to the call control server SV2 (see (16) in FIG. 10). The call control server SV2 sends ACK to the SIP terminal T21 (see (17) in FIG. 10). As a result, a communication link is formed, which connects the transmitting SIP terminal T11 and the receiving SIP terminal T21, by using the call control servers SV1-2 and SV2. Thereafter, RTP packets are transferred by using codec G.711 common to the SIP terminals T11 and T21, thereby accomplishing of RTP packet transfer between the SIP terminals T11 and T21.

RTP packets can be transferred directly between the SIP terminals T11 and T21, by directly using codec G.711 common to these SIP terminals T11 and T21, not through the call control server SV1-2.

### Other Embodiments

In each embodiment described above, an RTP session is established between SIP terminals. Instead, an RTP session may be established between, for example, a terminal on the public network and an SIP terminal. In this case, the RTP session is established between the SIP terminal and a gateway that is connected to the public network, by means of peer-to-peer connection.

Each embodiment described above uses SIP terminals. Instead, terminals using protocol other than SIP protocol may be used.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A telephone system in which a plurality of server apparatuses registering terminal apparatuses are connected by an Internet Protocol (IP)-QSIG dedicated line, thereby to achieve communication between the terminal apparatuses, the system comprising:
a transmitter configured to transmit a outgoing request from a first server apparatus to a second server apparatus, when a first terminal apparatus registered the first server apparatus is operated to transmit data to a second terminal apparatus registered the second server apparatus;
a detector configured to detect a response from the second terminal apparatus, at the second server apparatus;
a notification module configured to analyze media information received at the second server apparatus from the second terminal apparatus and required to achieve peer-to-peer communication, and to notify the media information to the first server apparatus, when the detector detects the response from the second terminal apparatus; and
a controller configured to cause the first server apparatus to perform the peer-to-peer communication between the first terminal apparatus and the second terminal apparatus based on the media information notified from the second server apparatus.

2. The telephone system of claim 1, wherein the first server apparatus comprises a notification controller configured to analyze media information on receiving the media information from the first terminal apparatus functioning as a transmitting terminal, and to notify the analyzed media information to the second server apparatus.

3. The telephone system of claim 1, wherein the controller analyzes the media information supplied from the second server apparatus and notifies the media information to the first terminal apparatus.

4. The telephone system of claim 1, wherein the notification module notifies at least one of codec data that can be used in the second terminal apparatus and data representing a packet transmission interval for the second terminal apparatus, as the media information, to the first server apparatus.

5. The telephone system of claim 1, wherein the notification module notifies the media information as data contained in a response message transmitted to the first server apparatus.

6. The telephone system of claim 1, wherein the notification module notifies the media information as data contained in a notification message different from a response message transmitted to the first server apparatus.

7. A call control server apparatus registering terminal apparatuses and being connected to an Internet Protocol (IP)-QSIG dedicated line, the call control server apparatus comprising:
a detector configured to detect a response from a receiving terminal apparatus when a outgoing request comes through the IP-QSIG dedicated line; and
a notification module configured to analyze media information received from the receiving terminal apparatus and required to achieve peer-to-peer communication, and to notify the media information to a transmitting terminal apparatus, when the detector detects the response from the receiving terminal apparatus.

8. The call control server apparatus of claim 7, further comprising a notification controller configured to analyze media information on receiving media information from the transmitting terminal apparatus and to notify the analyzed media information to the receiving terminal apparatus.

9. The call control server apparatus of claim 7, further comprising a notification controller configured to analyze media information on receiving media information from the receiving terminal apparatus and to notify the analyzed media information to the transmitting terminal apparatus.

10. The call control server apparatus of claim 7, wherein the notification module notifies at least one of codec data that can be used in the receiving terminal apparatus and data representing a packet transmission interval for the receiving terminal apparatus, as the media information, to the transmitting terminal apparatus.

11. The call control server apparatus of claim 7, wherein the notification module notifies the media information as data contained in a response message transmitted to the transmitting terminal apparatus.

12. The call control server apparatus of claim 7, wherein the notification module notifies the media information as data contained in a notification message different from a response message transmitted to the transmitting terminal apparatus.

13. A communication connection method for use in a telephone system in which a plurality of server apparatuses registering terminal apparatuses are connected by an Internet Protocol (IP)-QSIG dedicated line, thereby to achieve communication between the terminal apparatuses, the system comprising:
transmitting a outgoing request from a first server apparatus to a second server apparatus, when a first terminal apparatus registered the first server apparatus is operated to transmit data to a second terminal apparatus registered the second server apparatus;
detecting a response from the second terminal apparatus, at the second server apparatus;
analyzing media information received at the second server apparatus from the second terminal apparatus and required to achieve peer-to-peer communication, and notifying the media information to the first server apparatus, when the response from the second terminal apparatus is detected; and
performing the peer-to-peer communication between the first terminal apparatus and the second terminal apparatus based on the media information notified from the second server apparatus.

14. The communication connection method of claim 13, wherein the first server apparatus comprises analyzing media information on receiving the media information from the first terminal apparatus functioning as a transmitting terminal, and notifying the analyzed media information to the second server apparatus.

15. The communication connection method of claim 13, wherein the performing comprises analyzing the media information notified from the second server apparatus and supplying the analyzed media information to the first terminal apparatus.

16. The communication connection method of claim 13, wherein the notifying comprises notifying at least one of codec data that can be used in the second terminal apparatus and data representing a packet transmission interval for the second terminal apparatus to the first server apparatus.

17. The communication connection method of claim 13, wherein the notifying comprises notifying media information as data contained in a response message transmitted to the first server apparatus.

18. The communication connection method of claim 13, wherein the notifying comprises notifying media information as data contained in a notification message different from a response message transmitted to the first server apparatus.
